(19) United States
(12) Patent Application Publication
(10) Pub. No.: US 2009/0019854 A1
(43) Pub. Date: Jan. 22, 2009

(54) APPARATUS/METHOD FOR COOLING COMBUSTION CHAMBER/VENTURI IN A LOW NOx COMBUSTOR

(75) Inventors: Derrick Walter Simons, Greer, SC (US); William Kirk Hessler, Greer, SC (US); Neal Grooms, Simpsonville, SC (US); Jeffrey Lebegue, Simpsonville, SC (US)

Correspondence Address: CANTOR COLBURN, LLP, 20 Church Street, 22nd Floor, Hartford, CT, 06103, US

(73) Assignee: GENERAL ELECTRIC COMPANY, Schenectady, NY (US)

(21) Appl. No.: 11/778,345

(22) Filed: Jul. 16, 2007

(51) Int. Cl. F02C 7/08

(52) U.S. Cl. 60/738; 60/737; 60/752; 60/772

(57) ABSTRACT

A dry low nitric oxides (NOx) emissions combustor includes a premixing chamber for mixing fuel and cooling gas and a combustion chamber positioned downstream of the premixing chamber for the combustion of pre-mixed fuel and cooling gas. The combustor further includes a venturi having generally annular walls including converging and diverging wall portions that define a constricted portion and positioned between the premixing chamber and the combustion chamber through which the premixed fuel and air pass to the combustion chamber. The walls defining a passage for cooling gas flow extending axially along the combustion chamber and having an exit for flowing cooling gas to the combustion chamber. A plurality of inlets at the converging and diverging wall portions ingest cooling gas into the passage to produce an impingement cooling effect. A plurality of tubulators disposed downstream of the inlets interact with the cooling gas to produce a turbulated cooling effect. The combustor may be effectively fired over a substantial temperature range to reduce the NOx emissions of the combustor.

### BACKGROUND

This invention relates generally to an apparatus for the reduction of nitric oxide (NOx) emissions in a gas turbine combustion system. More specifically this invention relates to the apparatus for cooling the combustion chamber/venturi to lower nitric oxide emissions.

It is well known that the temperature of the turbine influences the efficiency of a gas turbine engine. Thereby there is a growing tendency to use higher temperatures, which leads to an increase of heat load on the turbine, as well as higher NOx emissions. It is also well known that NOx emissions increase exponentially as inlet temperatures of the combustor increases. This heat load on the turbine components is caused by the enormous amount of exposure to heat flux from the fuel air mix coming from the combustion chamber.

Government emissions regulations have become increasingly concerned in recent years pollutant emission of gas turbines. Nitric oxide being a contributor to air pollution made it a specific concern.

U.S. Pat. No. 5,117,636 deals with an apparatus for cooling the combustion chamber and the venturi walls. Where the apparatus uses compressed air from a single inlet to cool the venturi walls then exits in the downstream direction into the combustion chamber. It was found that in order to maintain an efficient combustor the cooled air would need to be dumped at a reasonable distance away from the venturi throat. Otherwise the cooling air will travel upstream into the combustion chamber known as backflow, compromising a stable flame.

U.S. Pat. No. 6,446,438 again deals with an apparatus for cooling the combustion chamber and venturi walls. In this case though the apparatus uses an upstream flow, redirecting cooled air into the premixing chamber, thusly no air is dumped into the combustion chamber.

This invention is concerned with improving the cooling of the combustion chamber, which includes the venturi walls while at the same time reducing nitric oxide emissions.

### BRIEF DESCRIPTION

A dry low nitric oxides (NOx) emissions combustor is presented that includes a premixing chamber for mixing fuel and cooling gas and a combustion chamber positioned downstream of the premixing chamber for the combustion of pre-mixed fuel and cooling gas. The combustor further includes a venturi having generally annular walls including converging and diverging wall portions that define a constricted portion and positioned between the premixing chamber and the combustion chamber through which the premixed fuel and air pass to the combustion chamber. The walls defining a passage for cooling gas flow extending axially along the combustion chamber and having an exit for flowing cooling gas to the combustion chamber. A plurality of inlets at the converging and diverging wall portions ingest cooling gas into the passage to produce an impingement cooling effect. A plurality of tubulators disposed downstream of the inlets interact with the cooling gas to produce a turbulated cooling effect. The combustor may be effectively fired over a substantial temperature range to reduce the NOx emissions of the combustor.

A method of dry low nitric oxides (NOx) emission in a combustor is also presented that includes premixing fuel and cooling gas, and constricting flow of the fuel and the cooling gas. The method further includes impingement cooling of the cooling gas and turbulated cooling of the cooling gas. The method still further includes combusting pre-mixed fuel and cooling gas over a substantial temperature range with reduced NOx emissions.

### BRIEF DESCRIPTION OF THE DRAWINGS

FIG. 1 is a simplified representation of a cross section of a gas turbine combustor system of the prior art;

FIG. 2 is a simplified representation of a cross section of a gas turbine combustor system of an exemplary embodiment of the present invention; and

FIG. 3 is a cross section of a forward integrating ring of the gas turbine combustor system of FIG. 2.

### DETAILED DESCRIPTION

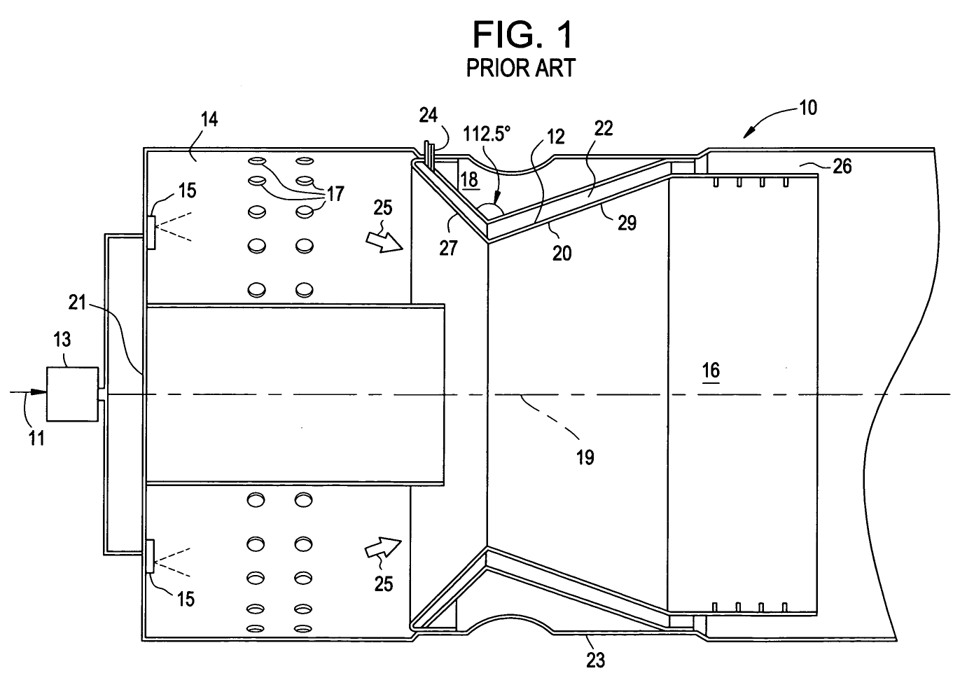

Referring to FIG. 1, an existing gas turbine combustor 10 is generally shown. The combustor 10 includes a venturi 12, an annual premixing chamber 14 for premixing air and fuel, and a combustor chamber 16. A turbine compressor (not shown) provides airflow into the premixing chamber 14 which then introduced with fuel creates a fuel air mix. Fuel 11 is provided through a fuel flow controller 13 to one or more fuel nozzles 15. Air is introduced through one or more entry ports 17. The combustion chamber 16 is generally cylindrical in shape about a combustor centerline 19 and is enclosed by a wall 21 and a parent liner or wall 23. This fuel-air mix travels in a downstream direction, as indicated by arrows 25, toward combustion chamber 16. Where the flow of the fuel-air mix is constricted by the convergent/divergent walls, 27 and 29, which define a cone having a cone angle of about 112.5 degrees. This constriction causes the fuel-air's mix to accelerate into the combustion chamber 16 where it will combust, this creates enormous amounts of heat flux on the venturi 12. The turbine compressor (not shown) provides the cooling air through inlet 24 to enter between upper wall 18 and lower wall 20 into channel 22, causing backside impingement cooling. The cooling air will then travel downstream through the channel 22 of the venturi cooling the walls of the channel 22. The cooling air exits along the combustion chamber wall through discharge opening 26. The air is then used in the cooling and combustion process within the combustion chamber 16.

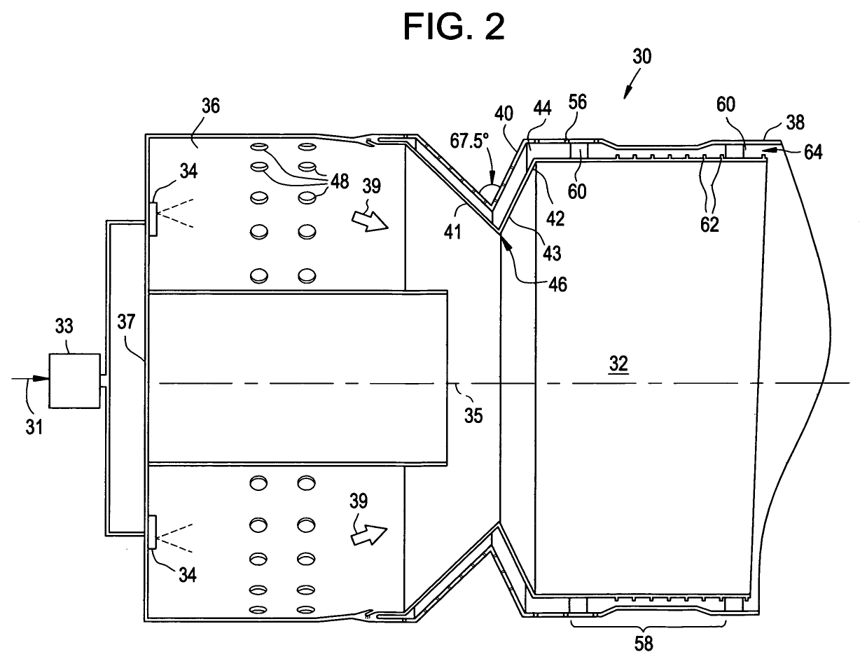

With Reference to FIG. 2, a gas turbine combustor of an embodiment of the invention is generally shown at 30. The gas turbine combustor 30 includes generally a combustion chamber 32, fuel nozzles 34 (some gas turbines, as illustrated here, employ multiple nozzles in each combustor), an annual premixing chamber 36, and a venturi 46. A turbine compressor (not shown) provides airflow into the premixing chamber 36 which then introduced with fuel creates a fuel air mix. Fuel 31 is provided through a fuel flow controller 33 to the fuel nozzles 34. Air is introduced through one or more entry ports 48. The combustion chamber 32 is generally cylindrical in shape about a combustor centerline 35 and is enclosed by a wall 37 and a parent liner or wall 38. The substantially cylindrical parent liner 38 comprises an upper wall 40 and a lower wall 42, defining the combustion chamber 32. The radial space between the upper wall 40 and the lower wall 42 defines an airflow passage or channel 44.

The fuel-air mix travels in a downstream direction, as indicated by arrows 39, toward combustion chamber 32. Where the flow of the fuel-air mix is constricted by the convergent/divergent walls, 41 and 43, which define a cone having a cone angle of about 67.5 degrees. However, a cone angle within a range of about 60 degrees to about 90 degrees is believed to provide the advantages of the invention of good performance and adequate cooling and is within the scope of the invention. The premixed fuel and air will then be introduced downstream into the combustion chamber 32. The flow constriction introduced by the venturi 46 will cause acceleration of the mix as it passes the convergent wall based upon Bernoulli's Principle, whereby an increase in velocity comes with a decrease in pressure. Accordingly, this causes the fuel-air's mix to accelerate into the combustion chamber 32 where it will combust, this creates enormous amounts of heat flux on the venturi 46, which is desirable to cool.

The venturi 46 provides multiple means of cooling. One means for cooling included backside impingement cooling, where the turbine compressor (not shown) provides the cooling air (compressed air) through a plurality of inlets or apertures 56 to enter between upper wall 40 and lower wall 42 into the channel 44. The inlets 56 are oriented on the upper wall 40 of the parent liner 38, and concentrated along the convergent and divergent walls of venturi 46. The cooling air will then travel downstream through the channel 44 of the venturi to a turbulated cooling portion 58.

The turbulated cooling portion 58 is constricted, whereby the upper wall 40 converges inwardly. To maintain this shape support strips 60 are located at the intake and discharge of the turbulated cooling portion 58. Within turbulated cooling portion 58, turbulators 62 are oriented longitudinally equidistant along the lower wall 42, directed inwardly toward upper wall 40 within venturi channel 44. The turbulators 62 create more contact between the cooling air and the metal of upper wall 40 and lower wall 42, thereby causing a better heat exchange due to turbulence.

The cooling air from the turbulated cooling portion 58 will then travel through channel 44 to the discharge opening 64. The discharge opening 64 then releases the cooling air into the combustion chamber 32 where it assists in providing a stable flame, in the combustion process as well as provide cooling to the combustion chamber 32.

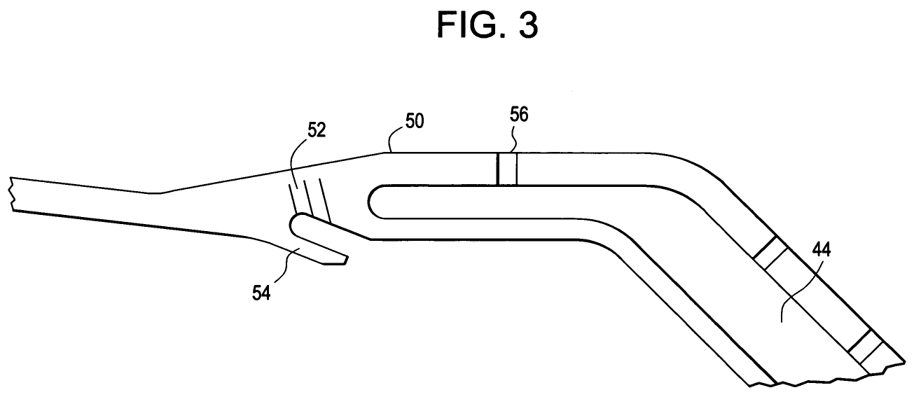

Referring also to FIG. 3 a forward integrating ring 50 is introduced to reduce the thermal stresses at the forward inner cone connection point on the channel 44, while maintaining an efficient cooling pattern. A leak free joint is also provided by the forward integrating ring 50. The forward integrating ring 50 has a solid body 52 and a angled fin 54 that shields a small segment of the channel 44 that receives limited amount of cooling, thereby helping decrease emissions. The fin 54 extends axially away from the solid body 52, covering a sufficient amount of channel 44 in order to reduce the thermal stresses.

This enhanced aforementioned multiple means of cooling the air in the combustor 30 reduces NOx emissions, while maintaining a stable flame. Further, the elimination of leaks paths with the introduction of the forward integrating ring 50 and the integration of the venturi 46 into the parent liner 38 significantly assist in the aforementioned means for controlling flow variation. Still further, a venturi cone angle of about 67.5 degrees also assist in the cooling without sacrificing performance. The use of the multiple cooling means, i.e., impingement and turbulating, conserves cooling air. A reduction in NOx emissions assists in compliance with government regulations.

While preferred embodiments have been shown and described, various modifications and substitutions may be made thereto without departing from the spirit and scope of the invention. Accordingly, it is to be understood that the present invention has been described by way of illustrations and not limitation.

1. A dry low nitric oxides (NOx) emissions combustor comprising:
a premixing chamber for mixing fuel and cooling gas;
a combustion chamber positioned downstream of the premixing chamber for the combustion of pre-mixed fuel and cooling gas; and
a venturi having generally annular walls including converging and diverging wall portions that define a constricted portion and positioned between the premixing chamber and the combustion chamber through which the premixed fuel and air pass to the combustion chamber, the walls defining a passage for cooling gas flow extending axially along the combustion chamber and having an exit for flowing cooling gas to the combustion chamber, a plurality of inlets at the converging and diverging wall portions ingest cooling gas into the passage to produce an impingement cooling effect, a plurality of tubulators disposed downstream of the inlets interact with the cooling gas to produce a turbulated cooling effect;
whereby the combustor may be effectively fired over a substantial temperature range to reduce the NOx emissions of the combustor.

2. The combustor of claim 1 wherein the converging and diverging wall portions define a cone angle between about 60 degrees and about 90 degrees.

3. The combustor of claim 2 wherein the cone angle is about 67.5 degrees.

4. The combustor of claim 1 wherein the venturi further includes a forward integrating ring having a solid body with a fin.

5. The combustor of claim 4 wherein the fin extends axially away from the solid body of the forward integrating ring.

6. The combustor of claim 1 wherein the venturi is integrated into a parent liner of the combustor.

7. The combustor of claim 1 wherein the passage is reduced in diameter where the turbulators are disposed.

8. A method of dry low nitric oxides (NOx) emission in a combustor, comprising:
premixing fuel and cooling gas;
constricting flow the fuel and the cooling gas;
impingement cooling of the cooling gas;
turbulated cooling of the cooling gas; and
combusting pre-mixed fuel and cooling gas over a substantial temperature range with reduced NOx emissions.

9. The method of claim 8 wherein the constricting flow of the premixed fuel and air comprises converging the flow of the premixed fuel and air and then diverging the flow of the premixed fuel and air, the converging and diverging occurring at an angle between about 60 degrees and about 90 degrees.

10. The method of claim 9 wherein the angle is about 67.5 degrees.

11. A dry low nitric oxides (NOx) emissions combustor comprising:
a premixing chamber for mixing fuel and cooling gas;
a combustion chamber positioned downstream of the premixing chamber for the combustion of pre-mixed fuel and cooling gas; and
a venturi having generally annular walls including converging and diverging wall portions that define a constricted portion and positioned between the premixing chamber and the combustion chamber through which the premixed fuel and air pass to the combustion chamber, the converging and diverging wall portions define a cone angle between about 60 degrees and about 90 degrees, the walls defining a passage for cooling gas flow extending axially along the combustion chamber and having an exit for flowing cooling gas to the combustion chamber, a plurality of inlets at the converging and diverging wall portions ingest cooling gas into the passage to produce an impingement cooling effect, a plurality of tubulators disposed downstream of the inlets interact with the cooling gas to produce a turbulated cooling effect, the passage being reduced in diameter where the turbulators are disposed;
whereby the combustor may be effectively fired over a substantial temperature range to reduce the NOx emissions of the combustor.

12. The combustor of claim 11 wherein the cone angle is about 67.5 degrees.

13. The combustor of claim 11 wherein the venturi further includes a forward integrating ring having a solid body with a fin.

14. The combustor of claim 13 wherein the fin extends axially away from the solid body of the forward integrating ring.

15. The combustor of claim 11 wherein the venturi is integrated into a parent liner of the combustor.
